(19) United States
(12) Patent Application Publication
(10) Pub. No.: US 2026/0254842 A1
(43) Pub. Date: Aug. 27, 2026

(54) SYSTEMS AND METHODS FOR MITIGATING RISKS OF THIRD-PARTY COMPUTING SYSTEM FUNCTIONALITY INTEGRATION INTO A FIRST-PARTY COMPUTING SYSTEM

(71) Applicant: OneTrust, LLC, Atlanta, GA (US)

(72) Inventors: Subramanian Viswanathan, San Ramon, CA (US); Milap Shah, Bengaluru (IN)

(21) Appl. No.: 19/649,949

(22) Filed: Apr. 16, 2026

Related U.S. Application Data
(63) Continuation of application No. 18/275,910, filed on Feb. 10, 2022, now Pat. No. 12,641,108.
(60) Provisional application No. 63/148,036, filed on Feb. 10, 2021.

(51) Int. Cl. H04L 9/40; G06F 21/60

(52) U.S. Cl. CPC H04L 63/1433; G06F 21/60

(57) ABSTRACT

In general, various aspects of the present invention provide methods, apparatuses, systems, computing devices, computing entities, and/or the like for integrating third party computing system functionality into a first party computing system by providing a risk management and mitigation computing system configured to analyze a risk of integrating the functionality provided by the third party computing system and facilitating implementation of one or more data-related controls that include performing computer-specific operations to mitigate and/or eliminate the identified risks. For example, the risk management and mitigation computing system can access risk data in tenant computing systems to determine a risk score related to the integration of the third party computing system functionality based on risks determined during prior integrations of the third party computing system functionality by other tenant computing systems. The risk management and mitigation computing system can generate a recommended control when integrating the third party computing system functionality.

### CROSS-REFERENCE TO RELATED APPLICATIONS

This application is a continuation of U.S. patent application Ser. No. 18/275,910, filed Aug. 4, 2023, which application is a national phase entry of International Patent Application No. PCT/US2022/015929, filed Feb. 10, 2022, which claims the benefit of U.S. Provisional Patent Application Ser. No. 63/148,036, filed Feb. 10, 2021, the entire disclosure of which are hereby incorporated herein by reference in their entirety.

### TECHNICAL FIELD

The present disclosure involves computer-implemented systems and processes for protection of system software or data from destruction, unauthorized modification, and/or unauthorized disclosures by, for example, facilitating implementation of controls when integrating third party computing system functionality into a first party computing system.

### BACKGROUND

A significant challenge encountered by many organizations is mitigating risks associated with integrating computer-related functionality provided by third party computing systems (e.g., software, storage, processing capacity, etc.). Providing access to an entity computing system by a third party computing system (e.g., for the purposes of transferring data, storing data, implementing software functionality on the entity computing system that utilizes the data, etc.) can expose the data to a signification risk of experiencing some type of data incident involving the data, such as a data breach leading to the unauthorized access of the data, a data loss event, etc. Therefore, a need exists in the art for improved systems and methods for reducing risks associated with such data loss events, while still enabling an entity to integrate third party computing functionality into entity computing systems.

### SUMMARY

A system comprising, in various aspects, comprises a non-transitory computer-readable medium storing instructions and a processing device communicatively coupled to the non-transitory computer-readable medium. In some aspects, the processing device is configured to execute the instructions and thereby perform operations comprising: (1) responsive to a request to integrate third party computing system functionality into a first party computing system, initiating a risk analysis for the third party computing system functionality; (2) accessing tenant computing system risk data for the third party computing system functionality, the tenant computing system risk data comprising risk data for each of a plurality of tenant computing systems that have previously integrated the third party computing system functionality; (3) identifying particular risks for integrating the third party computing system functionality based on the tenant computing system risk data; (4) determining a respective normalized risk score for each of the particular risks for each tenant computing system of the plurality of computing systems; (5) accessing tenant computing system control data for the particular risks identified for the third party computing system functionality; (6) determining, based on the tenant computing system control data, a common control set implemented by the plurality of tenant computing systems to mitigate risks for integrating the third party computing system functionality; (7) determining a mitigation weight of each control in the common control set based on the respective normalized risk score for each of the particular risks and the tenant computing system control data; (8) determining control adoption data for each of the plurality of tenants based on the tenant computing system control data; (9) processing the common control set, the mitigation weight, and the control adoption data using at least one of a rules-based model or a machine-learning model to generate a control recommendation, the control recommendation comprising at least one control from the common control set; and (10) facilitating implementation of at least one control identified by the control recommendation related to the integration of the third party computing system functionality into the first party computing system.

In some aspects, the operations further comprise modifying the tenant computing system control data to include new control data for the first party computing system, the new control data indicating the control recommendation as a control implemented by the first party computing system for at least one of the particular risks. In other aspects, the operations further comprise determining a residual risk rating for each of the particular risks based on the respective normalized risk score for each of the particular risks and the mitigation weight of each control in the common control set, and generating the control recommendation further comprises processing the residual risk rating using the at least one of the rules-based model or the machine-learning model to generate the control recommendation. In some aspects, the operations further comprise determining a control mitigation score for the functionality provided by the third party computing system based on a respective tenant control mitigation score for each tenant computing system of the plurality of computing systems. In other aspects, generating the control recommendation further comprises processing the control mitigation score for the functionality provided by the third party computing system using the at least one of the rules-based model or the machine-learning model to generate the control recommendation.

In some aspects, the tenant computing system control data defines: (1) for a first tenant computing system of the plurality of tenant computing systems, a first risk, a first risk score for the first risk, a first control for the first risk, and a first control score for the first control; and (2) for a second tenant computing system of the plurality of tenant computing systems, a second risk, a second risk score for the second risk, a second control for the second risk, and a second control score for the first control. In various aspects, determining the mitigation weight of each control in the common control set based on the respective normalized risk score for each of the particular risks and the tenant computing system control data comprises comparing the first risk score to the first control score and the second risk score to the second control score to determine a relative control mitigation score between the first control and the second control, and processing the common control set, the mitigation weight, and the control adoption data using at least one of a rules-based model or a machine-learning model to generate a control recommendation comprises using the rules-based model to select the control recommendation from the first control or the second control based on the relative control mitigation score.

In some aspects, processing the common control set, the mitigation weight, and the control adoption data comprises using the rules-based model to generate the control recommendation; and the rules-based model comprises a set of rules that selects the control recommendation from the common control set based on at least one of a relative mitigation weight of each control in the common control set or a relative adoption rate of each control in the common control set. In any aspect described herein, facilitating implementation of the at least one control identified by the control recommendation comprises at least one of facilitating modification of the third party computing system functionality or facilitating disabling of the third party computing system functionality.

A method according to various aspects comprises: (1) initiating, by computing hardware, a risk analysis for integrating functionality provided by a third party computing system into a first party computing system; (2) accessing, by the computing hardware, tenant computing system risk data for the functionality provided by the third party computing system, the tenant computing system risk data comprising risk data for each of a plurality of tenant computing systems that have previously integrated the functionality provided by the third party computing system; (3) identifying, by the computing hardware, particular risks for integrating the functionality provided by the third party computing system based on the tenant computing system risk data; (4) determining, by the computing hardware, a respective normalized risk score for each of the particular risks for each tenant computing system of the plurality of computing systems; (5) accessing, by the computing hardware, tenant computing system control data for the particular risks identified for the functionality provided by the third party computing system; (6) determining, by the computing hardware based on the tenant computing system control data, a common control set implemented by the plurality of tenant computing systems to mitigate risks for integrating the functionality provided by the third party computing system; (7) determining, by the computing hardware, a mitigation weight of each control in the common control set based on the respective normalized risk score for each of the particular risks and the tenant computing system control data; (8) causing, by the computing hardware, at least one of a rules-based model or a machine-learning model to process the common control set and the mitigation weight to generate a control recommendation, the control recommendation comprising at least one control from the common control set; and (9) causing, by the computing hardware, implementation of at least one control identified by the control recommendation related to the integration of the functionality provided by the third party computing system into the first party computing system.

In some aspects, the method further comprises determining, by the computing hardware, a control mitigation score for the functionality provided by the third party computing system based on a respective tenant control mitigation score for each tenant computing system of the plurality of computing systems. In other aspects, generating the control recommendation further comprises processing the control mitigation score for the functionality provided by the third party computing system using the at least one of the rules-based model or the machine-learning model to generate the control recommendation. In particular aspects, the method further comprises modifying the tenant computing system control data to include new control data for the first party computing system, the new control data indicating the control recommendation as a control implemented by the first party computing system for at least one of the particular risks.

In some aspects, the method further comprises determining, by the computing hardware, a residual risk rating for each of the particular risks based on the respective normalized risk score for each of the particular risks and mitigation weight of each control in the common control set; and generating the control recommendation further comprises processing the residual risk rating using the at least one of the rules-based model or the machine-learning model to generate the control recommendation. In some aspects, the rules-based model comprises a set of rules that selects the control recommendation from the common control set based on a relative mitigation weight of each control in the common control set. In any aspect described herein, causing the implementation of at least one control identified by the control recommendation can comprise at least one of causing modification of the functionality provided by third party computing system, causing disabling of the functionality provided by third party computing system, or generating a user interface that includes the at least one control and providing the user interface for display on a user device. In some aspects, the method comprises modifying, by the computing hardware, the tenant computing system control data to include new control data for the first party computing system, the new control data indicating the control recommendation as a control implemented by the first party computing system for at least one of the particular risks.

A system comprising, in various aspects, comprises a non-transitory computer-readable medium storing instructions and a processing device communicatively coupled to the non-transitory computer-readable medium. In some aspects, the processing device is configured to execute the instructions and thereby perform operations comprising: (1) initiating a risk analysis for integrating functionality provided by a third party computing system into a first party computing system; (2) accessing tenant computing system risk data for the functionality provided by a third party computing system, the tenant computing system risk data comprising risk data for a first tenant computing system and a second tenant computing that have previously integrated the functionality provided by a third party computing system; (3) identifying, based on the tenant computing system risk data, a first set of risks indicated by the first tenant computing system and a second set of risks indicated by the second tenant computing system; (4) determining a first risk score for the first set of risks score and a second risk score for the second set of risks; (5) accessing tenant computing system control data for the first set of risks and the second set of risks, the tenant computing system control data comprising a first set of controls for the first set of risks and a second set of controls for the second set of risks; (6) determining, based on the first set of risks and the second set of risks, a common control set implemented by the first tenant computing system and the second tenant computing system to mitigate the first set of risks and the second set of risks; (7) determining a mitigation weight of each control in the common control set based on the first risk score, the second risk score and the tenant computing system control data; (8) processing the common control set and the mitigation weight of each control using a rules-based model to generate a control recommendation, the control recommendation comprising at least one control from the common control set; and (9) facilitating implementation of at least one control identified by the control recommendation related to the integration of the functionality provided by the third party computing system into the first party computing system.

In some aspects, the first set of controls and the second set of controls comprise a first common control. In such aspects, determining the mitigation weight of each control in the common control set comprises determining a first mitigation score for mitigation of the first set of risks by the first common control and a second mitigation score for mitigation of the second set of risks by the first common control. In still further aspects, processing the common control set and the mitigation weight of each control using a rules-based model to generate the control recommendation comprises applying a set of rules defining a rule to select the first common control as the control recommendation for the first set of risks or the second set of risks based on the first mitigation score and the second mitigation score. In various aspects, the rules-based model comprises a set of rules that selects the control recommendation from the common control set based on a relative mitigation weight of each control in the common control set.

According to any aspect described herein, the operations further comprise generating a graphical user interface by configuring a display element for displaying the control recommendation and at least one of the first set of risks and the second set of risks. In some aspects, facilitating implementation of the at least one control identified by the control recommendation related to the integration of the functionality provided by the third party computing system into the first party computing system comprises providing the graphical user interface for display on a user device. In various aspects, the operations further comprise modifying the tenant computing system control data to include new control data for the first party computing system, the new control data indicating the control recommendation as a control implemented by the first party computing system for at least one of the first set of risks or the second set of risks. In still other aspects, facilitating implementation of the at least one control identified by the control recommendation comprises at least one of facilitating modification of the functionality provided by the third party computing system or facilitating disabling of the functionality provided by the third party computing system.

### BRIEF DESCRIPTION OF THE DRAWINGS

In the course of this description, reference will be made to the accompanying drawings, which are not necessarily drawn to scale, and wherein:

FIG. 1 depicts an example of a computing environment that can be used for analyzing data-related risks associated with integrating functionality provided by a third party computing system into a tenant computing system and facilitating implementation of controls to mitigate the identified risks accordance with various aspects of the present disclosure;

FIG. 2 depicts an example of a process for initiating a process for integrating third party computing system functionality into a tenant computing system in accordance with various aspects of the present disclosure;

FIG. 3 depicts an example of a process for identifying and determining data-related risks when integrating third party computing system functionality into a tenant computing system in accordance with various aspects of the present disclosure;

FIG. 4 depicts an example of a process for generating control recommendations for mitigating the data-related risks of integrating third party computing system functionality into a tenant computing system of in accordance with various aspects of the present disclosure;

FIG. 5 depicts an example of a process for facilitating implementation of controls for mitigating data-related risks of integrating third party computing system functionality into a tenant computing system in accordance with yet another aspect of the present disclosure;

FIG. 6 depicts an example of a system architecture that may be used in accordance with various aspects of the present disclosure; and

FIG. 7 depicts an example of a computing entity that may be used in accordance with various aspects of the present disclosure.

### DETAILED DESCRIPTION

### Overview and Technical Contributions of Various Aspects

As noted above, a significant challenge encountered by many organizations is the risk associated with integrating computer-related functionality provided by third party computing systems (e.g., software, storage, processing capacity, etc.) into a first party computing system (e.g., a tenant computing system). In particular, integrating third party computing system functionality into a first party computing system may include, for example, transferring data between the first party and third party computing systems, providing access to data stored on the first party computing system to the third party computing system, etc. As such, integrating third party computing system functionality into a first party computing system may introduce risks related to transferring data between the computing systems, providing access to the external, third party computing system, etc. For example, transferring data between computing systems (e.g., from a first party computing system to a third party computing system in order to provide computing functionality available at the third party computing system to the data) can expose the data to a significant risk of experiencing some type of data incident involving the data, such as a data breach leading to the unauthorized access of the data, a data loss event, etc. As such, it may be technically difficult to integrate third party computing system functionality into a first party computing system without increasing the risk of such exposure.

Accordingly, various aspects of the present disclosure overcome many of the technical challenges mentioned above associated with integrating third party computing system functionality into a first party computing system by providing a risk management and mitigation computing system configured to analyze a risk of integrating the functionality provided by the third party computing system and facilitating implementation of one or more data-related controls that include performing computer-specific operations to mitigate and/or eliminate the identified risks. For example, the risk management and mitigation computing system can access risk data in tenant computing systems to determine a risk score related to the integration of the third party computing system functionality based on risks determined during prior integrations of the third party computing system functionality by other tenant computing systems. The risk management and mitigation computing system can further generate a recommended control (e.g., or controls) to implement at the first party computing system and/or the third party computing system when integrating the third party computing system functionality. The risk management and mitigation computing system can use a rules-based model, a machine-learning model, or some combination thereof to determine the risk and generate the recommended control. Certain aspects described herein provide improvements in generating a recommended control by applying various rules of a particular type, such as algorithms related to selecting among a set of controls based on effectiveness in mitigating specific identified risks, to control the manner in which computing devices process certain data (e.g., mitigation weight of various controls, adoption frequency of particular controls) to generate control recommendations.

Various aspects of the disclosure provided herein address technical disadvantages encountered in designing or implementing various software applications and other third party computing functionality to a first party computing system. Specifically, various aspects of the disclosure provide a computing system control recommendation engine that can generate a control action for mitigating the risk involved in the first party computing system's use of the third party computing system functionality. The first party computing system can then facilitate implementation of the control action in order to mitigate the risk. Further, the first party computing system can perform operations so that the risk is addressed accordingly, such as by implementing one or more controls causing the functionality provided by the third party computing system to be modified or disabled. As a result, various aspects of the disclosure can increase the security, reliability, capacity, and efficiency in using third party computing system functionality in a first party computing system. In doing so, various aspects of the present disclosure make major technical contributions to improving the use of such functionality. This in turn translates to more computationally reliable, secure, and/or efficient systems.

In the course of this description, reference is made to integrating third party computing system functionality into a first party computing system (e.g., or other computing system). Integrating third party computing system functionality can include a third party computing system providing any computing functionality available on the third party computing system to the first party computing system. For example, in various aspects, integrating third party computing system functionality into a first party computing system can include initiating network communications between the third party computing system and the first party computing system; transferring data between the first party computing system and the third party computing system; providing access, to the first party computing system, to data storage available on the third party computing system; providing, by the third party computing system, one or more software applications for installation on the first party computing system; providing access, by the third party computing system, to one or more cloud-based software applications to the first party computing system; and the like.

### Example Computing Environment

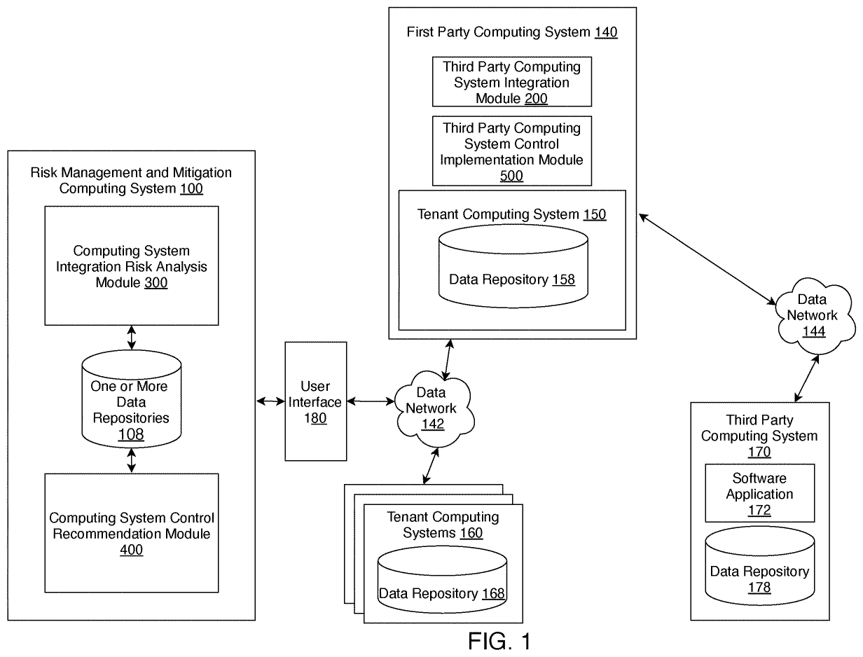

FIG. 1 depicts an example of a computing environment that can be used for analyzing data-related risks associated with integrating functionality provided by a third party computing system 170 into a first party computing system 140 (e.g., tenant computing system 150) and facilitating implementation of controls and other modifications to mitigate the identified risks in accordance with various aspects of the present disclosure. In various aspects, the controls may include any suitable control, such as those defined by the National Institute of Standards and Technology (NIST), International Organization for Standardization (ISO), etc. In various aspects, the controls may relate to, for example, information security, data access control, operations security, communications security (e.g., network communication security), etc.

FIG. 1 depicts examples of hardware components of a risk management and mitigation computing system 100 according to some aspects. The risk management and mitigation computing system 100 is a specialized computing system that can be used for performing risk analysis related to the integration of functionality provided by a third party computing system 170 to a first party computing system 140. In some aspects, a first party computing system 140 may include a computing system that is operated by a particular entity (e.g., an organization). For example, the first party computing system may include a collection of computing hardware and software over which an entity has control. A third party computing system 170 may include a computing system that is operated by an entity other than the particular entity. For example, the third party computing system 170 may include computing hardware and software that the particular entity has no control over or access to, but which provides some functionality that the particular entity may desire to utilize (e.g., in conjunction with the first party computing system 140). In various aspects, the first party entity may provide compensation to the third party entity in exchange for utilizing the third party computing system functionality provided by the third party computing system 170.

In various aspects, the risk management and mitigation computing system 100 includes a specialized computing system that may be used for generating recommendations for implementing controls for the purpose of mitigating the risks identified with integrating the functionality provided by the third party computing system 170 to the first party computing system 140. In some aspects, the risk management and mitigation computing system 100 utilizes risk and control data received from tenant computing systems 160 from prior integrations of the functionality provided by the third party computing system 140 into other first party systems (e.g., other first party systems associated with the tenant computing systems 160).

The risk management and mitigation computing system 100 can communicate with various computing systems, such as tenant computing systems 160 (e.g., over a data network 142, such as the internet). In various aspects, the risk management and mitigation computing system 100 can receive tenant computing system control data and tenant computing system risk data (e.g., over the data network 142) related to integration, by the respective tenant computing systems 160, of the functionality provided by the third party computing system 170. The tenant computing system control data and tenant computing system risk data may define, for example, data related to risk analysis and control implementation by the tenant computing systems when integrating the third party computing system functionality. The risk management and mitigation computing system 100 may store the tenant computing system control data and tenant computing system risk data in one or more data repositories 108 on the risk management and mitigation computing system 100. The risk management and mitigation computing system 100 may include computing hardware performing a number of different processes in determining risk scores for each of a plurality of identified risks associated with integrating the third party computing system functionality into the first party computing system 140 and generating control recommendations for mitigating identified risks. Specifically, according to various aspects, the risk management and mitigation computing system 100 executes: (1) a computing system integration risk analysis module 300 to determine risk scores for each of a plurality of identified risks associated with integrating the third party computing system functionality into the first party computing system 140.; and/or (2) a computing system control recommendation module 400 to generate a control recommendation to mitigate risks related to integrating the third party computing system functionality into the first party computing system 140.

The risk management and mitigation computing system 100 can also communicate with a first party computing system 140 (e.g., over a data network 142, such as the internet). The first party computing system may include a computing system that is initiating, in the process of integrating, or has completed an integration of functionality provided by the third party computing system. In various aspects, the first party computing system includes a tenant computing system 150. In various aspects, the risk management and mitigation computing system 100 may receive one or more requests from the first party computing system 140 (e.g., via a user interface 180) to analyze a risk for integrating functionality provided by the third party computing system 170 to the first party computing system 140 or to mitigate one or more risks (or provide risk mitigation data) to the first party computing system 140 for use in mitigating the identified risks related to integrating the third party computing system functionality into the first party computing system 140.

According to various aspects, the first party computing system 140 may include computing hardware performing a number of different processes in initiating and implementing integration of third party computing system functionality into the first party computing system 140. Specifically, according to particular aspects, the first party computing system 140 executes: (1) a third party computing system integration module 200 to initiate a third party computing system functionality risk analysis in response to a request to integrate functionality provided by the third party computing system 170 into the first party computing system 140; and/or (2) a third party computing system control implementation module 500 to facilitate implementation of one or more controls based on a control recommendation for integrating the third party computing system functionality into the first party computing system 140.

The first party computing system 140 (e.g., or other suitable system) may execute the third party computing system integration module 200 to perform operations including initiating integration of functionality provided by the third party computing system 170 on the first party computing system 140 by: (1) receiving a request to integrate the third party computing system functionality at the first party computing system 140; (2) initiating a risk analysis for the third party computing system functionality; (3) receiving risk analysis and recommended control data; and/or (4) initiating the integration of the third party computing system functionality into the first party computing system 140 (e.g., based on the risk analysis and recommended control data).

The first party computing system 140 (e.g., or other suitable system) may execute the third party computing system control implementation module 500 to facilitate implementation of one or more controls at the first party computing system 140 and/or the third party computing system 170. The first party computing system 140 may, for example, receive control recommendation data determined by the risk management and mitigation computing system 100, and facilitate implementation of at least one control based on the control recommendation data (e.g., facilitate implementation of at least one control at the first party computing system 140, at the third party computing system 170, etc.).

The first party computing system can include a tenant computing system 150, which may include one or more data repositories 158. In various aspects the tenant computing system 150 and the tenant computing systems 160 are part of a multi-tenant system in which a single instance of software and its supporting architecture (e.g., the risk management and mitigation computing system 100 and associated modules) serve multiple tenant systems. In such aspects, each of the tenant computing system 150 and the tenant computing systems 160 have respective data repositories 158, 168. In particular aspect, a multi-tenant configuration may provide additional technical advantages to various aspects of the present disclosure. In particular, in some aspects, the risk management and mitigation computing system may have access to each of the data repositories 168 for the respective tenant computing systems 168. In this way, although each tenant computing system 160, 150 maintains data in a secure data repository 168, 158 (e.g., or a secure portion of the one or more data repositories 108) the risk management and mitigation computing system 100 may access the tenant computing system control data and tenant computing system risk data for use in risk analysis sand control recommendation processes. In various aspects, the risk management and mitigation computing system 100 may anonymize the tenant computing system control data and tenant computing system risk data such that the data is available for risk analysis and control recommendation processes without revealing which particular one of the tenant computing systems 160 assigned a particular risk level or implemented a particular control. In various aspects, this configuration may provide additional technical advantages by providing improved design and implementation various software applications for determining risks and generating control recommendations, by providing access to data that may otherwise be unavailable to the software.

As shown in FIG. 1, the computing environment further includes a third party computing system, which can communicate with the first party computing system 140 over a data network 144. The third party computing system 170 can include one or more software applications 172 and a data repository 178. In various aspects, the third party computing system may have available computing functionality (e.g., such as data storage on the data repository, software functionality provided by the software application(s) 172, processing capability, etc.).

In various aspects, the third party computing system may communicate (e.g., transmit data to, receive data from, etc.) the first party computing system 140. In various aspects, the third party computing system 170 may provide functionality to the first party computing system 140 (e.g., via the data network 144) following the implementation of one or more controls described herein.

The number of devices depicted in FIG. 1 are provided for illustrative purposes. In some aspects, different number of devices may be used. In various aspects, for example, while certain devices or systems are shown as single devices in FIG. 1, multiple devices may instead be used to implement these devices or systems.

In some aspects, the risk management and mitigation computing system 100 can include one or more third-party devices such as, for example, one or more servers operating in a distributed manner. The risk management and mitigation computing system 100 can include any computing device or group of computing devices, and/or one or more server devices

Although the data repositories 108, 158, 168, 178 are shown as separate components, these components 120 may include, in other aspects, a single server and/or repository, servers and/or repositories, one or more cloud-based servers and/or repositories, or any other suitable configuration.

### Third Party Computing System Integration Module

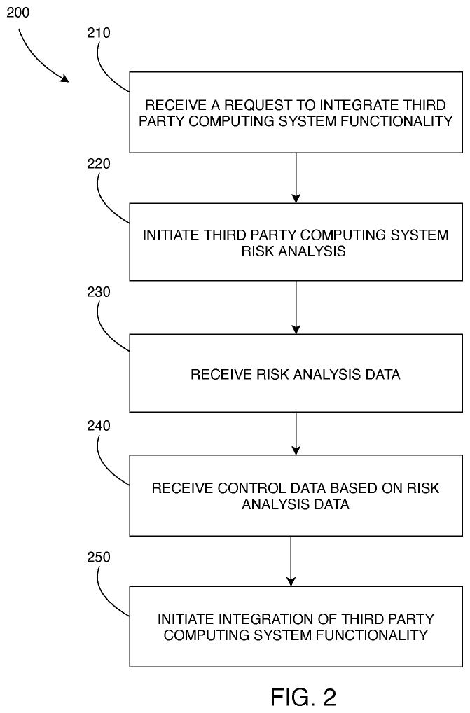

FIG. 2 depicts an example of process performed by a third party computing system integration module 200. This process include operations that the first party computing system 140 may execute to initiate a third party computing system functionality risk analysis in response to a request to integrate functionality provided by the third party computing system 170 into the first party computing system 140. For instance, the flow diagram shown in FIG. 2 may correspond to operations carried out, for example, by computing hardware found in the first party computing system 140 as the computing hardware executes the third party computing system integration module 200.

In various aspects, the first party computing system 140 (e.g., when executing steps related to the third party computing system integration module 200) initiates the third party computing system functionality risk analysis and receives risk analysis and control data for use in initiating the integration of the third party computing system functionality into the first party computing system 140.

At operation 210, the third party computing system integration module 200 receives a request to integrate third party computing system functionality into the first party computing system 140. In various aspects, the third party computing system functionality may include any computing functionality provided by the third party computing system 170. In some aspects, the third party computing functionality may include, for example, one or more software applications 172 that may execute on the third party computing system 170 or on the first party computing system once the third party computing system provides the one or more software applications 172 to the first party computing systems 140, access to one or more data repositories 178 on the third party computing system 170 by the first party computing system 140 (e.g., such as for data storage, backup, etc.), and the like.

In some aspects, the first party computing system 140 may receive the request to integrate the third party computing system functionality via a user interface accessible via a user device in the first party computing system 140. As discussed herein, integrating functionality from a third party computing system 170 into a first party computing system 140 may introduce risks related to transferring data between the computing systems, providing access, by the third party computing system 170 to the first party computing system 140, etc. For example, transferring data between computing systems (e.g., from a first party computing system 140 to a third party computing system 170 in order to provide computing functionality available at the third party computing system 170 to the first party computing system 140) can expose the data to a signification risk of experiencing some type of data incident involving the data, such as a data breach leading to the unauthorized access of the data, a data loss event, etc.

In one example the request to integrate the third party computing system functionality may include a request to utilize, at the first party computing system 140 software or computing hardware provided by a third-party vendor. This may include, for example, cloud based computer storage, credit card processing software, etc.

As such, at operation 220, the third party computing system integration module 200 initiates a third party computing system risk analysis related to the integration of the third party computing system functionality into the first party computing system 140. For example, the first party computing system 140 may transmit one or more requests or instructions to the risk management and mitigation computing system 100 to cause the risk management and mitigation computing system 100 to perform processing operations and/or network communications related to determining one or more risks related to the integration of the third party computing system functionality into the first party computing system 140. For example, the first party computing system 140 may cause the risk management and mitigation computing system 100 to perform one or more operations related to the computing system integration risk analysis module 300 described more fully below.

In other aspects, initiating the third party computing system risk analysis related to the integration of the third party computing system functionality into the first party computing system 140 may include, for example, generating and/or transmitting one or more risk assessments to the third party computing system 170 for completion, generating/and or providing one or more risk assessments to the first party computing system 140 for completion by a user of the first party computing system, etc.

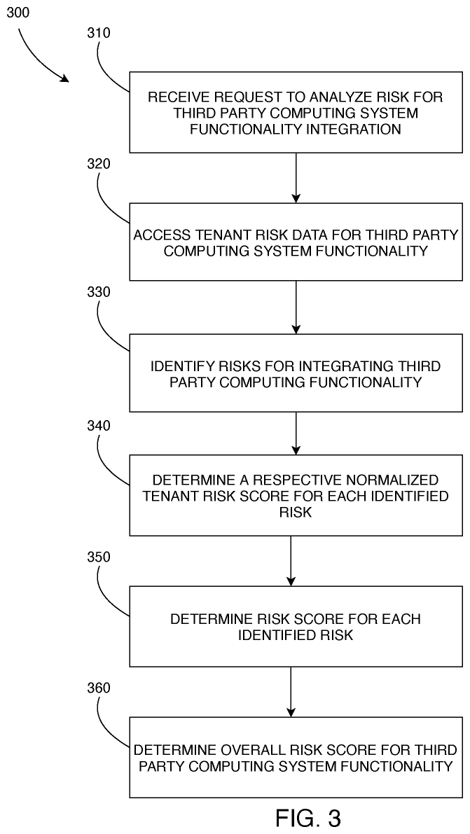

At operation 230, the third party computing system integration module 200 receives risk analysis data 230. In particular aspects, the first party computing system receives the risk analysis data from the risk management and mitigation computing system 100. In some aspects, the risk analysis data includes data determined during execution of the computing system integration risk analysis module 300 discussed below with respect to FIG. 3. In particular aspects, the first party computing system 140 stored the risk analysis data (e.g., in the data repository 158 of its tenant computing system 150). In some aspects, the first party computing system 140 may provide the risk analysis data from the tenant computing system 150 to the risk analysis and control identification computing system 100 for use in one or more additional risk analyses related to integration of functionality provided by the third party computing system 170.

In some aspects the first party computing system 140 may generate one or more display elements for inclusion in a graphical user interface. The first party computing system 140 may configure the one or more display elements to display at least some of the risk analysis data (e.g., a determined overall risk of integrating the third party computing system functionality into the first party computing system 140, a risk rating for particular risks identified with integrating the third party computing system functionality into the first party computing system 140, etc.). The first party computing system 140 may then provide the GUI for display on a user device.

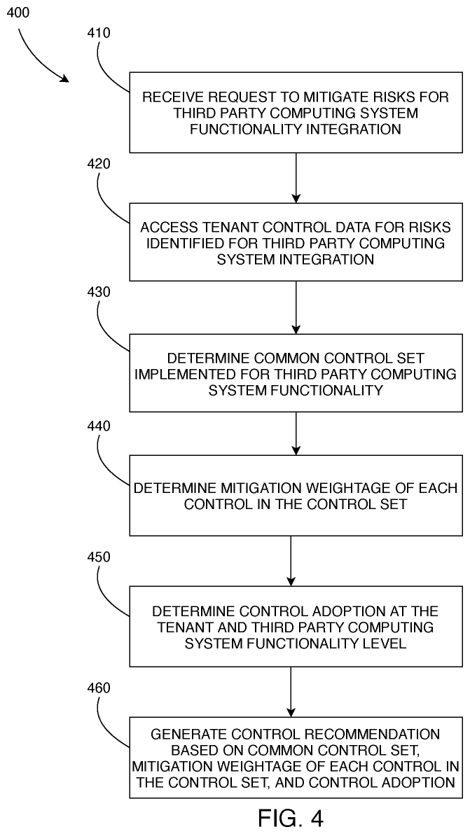

Continuing to operation 240, the third party computing system integration module 200 receives control data based on the risk analysis data. For example, in some aspects, the first party computing system 140 receives the control data from the risk management and mitigation computing system 100. In some aspects, the control data includes a control recommendation, which the risk management and mitigation computing system 100 may have generated using the computing system control recommendation module 400 discussed more fully below with respect to FIG. 4. For example, as discussed more fully below, the risk analysis data may include a set of identified risks and an associated risk score for each of the tenant computing systems. The third party computing system integration module 200 may receive control data based on the risk analysis data by accessing control data for each risk in the set of identified risks. In this way, the third party computing system integration module 200 may receive control data for implemented controls that is limited to controls for the actual risks identified for the third party computing system functionality integration. In one aspect, the first party computing system 140 stores the control data (e.g., in the data repository 158 of its tenant computing system 150). In some aspects, the first party computing system 140 may provide the control data from the tenant computing system 150 to the risk analysis and control identification computing system 100 for use in one or more future risk mitigation analyses related to the integration of functionality provided by the third party computing system 170.

In some aspects, the first party computing system 140 may configure the one or more display elements to display at least some of the control analysis data (e.g., a generated control recommendation related to integrating the third party computing system functionality into the first party computing system 140, etc.).

At operation 250, the third party computing system integration module 200 initiates integration of the third party computing system functionality into the first party computing system 100. In various aspects, initiating the integration of the third party computing system functionality into the first party computing system 140 may include, for example, the first party computing system 140 implementing one or more controls based on the control data (e.g., facilitating implementation of the one or more controls at the first party computing system 140 and/or the third party computing system 170). In other aspects the first party computing system 140 may initiate integration of the third party computing system functionality by initiating processing operations or network communications for providing and/or accessing the functionality from the third party computing system 170 at the first party computing system. This may include, for example, initiating network communications between the first party computing system 140 and the third party computing system 170, transferring data and/or software to and/or from the third party computing to the first party computing system 140, etc.

For illustrative purposes, the third party computing system integration module 200 is described with reference to implementations described above with respect to one or more examples described herein. Other implementations, however, are possible. In some aspects, the steps in FIG. 2 may be implemented in program code that is executed by one or more computing devices such as the, the first party computing system 140, the risk management and mitigation computing system 100, or other system in FIG. 1. In some aspects, one or more operations shown in FIG. 2 may be omitted or performed in a different order. Similarly, additional operations not shown in FIG. 2 may be performed.

### Computing System Integration Risk Analysis Module

FIG. 3 depicts an example of a process performed by a computing system integration risk analysis module 300. This process may, for example, include operations that the risk management and mitigation computing system 100 may execute to determine risk scores for each of a plurality of identified risks associated with integrating the third party computing system functionality into the first party computing system 140. For instance, the flow diagram shown in FIG. 3 may correspond to operations performed by computing hardware found in the risk management and mitigation computing system 100 that executes the computing system integration risk analysis module 300.

At operation 310, the computing system integration risk analysis module 300 receives a request to analyze risk for third party computing system functionality integration (e.g., third party computing system functionality integration into a first party computing system 140). In some aspects, the computing system integration risk analysis module 300 receives the request in response to a request to integrate third party computing system functionality into the first party computing system 140 (e.g., such as discussed above with respect to operation 210 of the third party computing system integration module 200 shown in FIG. 2).

In operation 320, the computing system integration risk analysis module 300 accesses tenant computing system risk data for the third party computing system functionality. In some aspects, the risk management and mitigation computing system 100 accesses the tenant computing system risk data from the one or more data repositories 108 on the risk management and mitigation computing system 100. In various aspects, the risk management and mitigation computing system 100 may receive the tenant computing system control data from one or more data repositories 168 in the tenant computing systems 160. In various aspects, the tenant computing system risk data includes data related to one or more risks identified by various tenant computing systems 160 when integrating the third party computing system functionality into the tenant computing systems 160 (or other first party computing systems associated with the tenant computing systems 160) at a past time. For example, the tenant computing risk data may include a set of identified risks and an associated risk score for each of the tenant computing systems, where the set of identified risks and the associated risk scores were determined during a process in which each of the tenant computing systems 160 integrated the third party computing system functionality (e.g., during an iteration of the computing system integration risk analysis module 300 executed on behalf of the tenant computing systems 160 while the tenant computing systems 160 were integrating the functionality provided by the third party computing system 170).

In various aspects, each of the tenant computing systems 160 may utilize different scoring values for each of the identified risks. For example, each of the tenant computing systems 160 may define a respective scoring scale (e.g., set of scoring ranges) that corresponds to an indication of a risk level for a particular identified risk (e.g., low, medium high).

In one example, the computing system integration risk analysis module 300 may access the following tenant computing system risk data for a first functionality (F1) provided by the third party computing system 170:

TABLE 1
Exemplary Tenant Computing System Risk Data

| Tenant | Risk Score Ranges | Risks | Risk Score | Level |
|---|---|---|---|---|
| T1 | Low: 1-5 | R1 | 5 | Low |
| | Medium: 6-10 | R2 | 10 | Medium |
| | High: 11-15 | R3 | 15 | High |
| T2 | Low: 1-2 | R1 | 1 | Low |
| | Medium: 3-6 | R2 | 3 | Medium |
| | High: 7-10 | R3 | 8 | High |
| T3 | Low: 1-10 | R1 | 8 | Low |
| | Medium: 11-20 | R2 | 17 | Medium |
| | High: 21-30 | R3 | 27 | High |

At operation 330, the computing system integration risk analysis module 300 identifies risks for integrating the third party computing functionality into the first party computing system 140 (e.g., based on the tenant computing system risk data). In the integration process, each of the tenant computing systems 160 may initiate a risk analysis for identifying risks and respective scores for each identified risk at the time of the integration. Continuing the example above, in the tenant computing system risk data, each of three tenant computing systems (e.g., T1, T2, and T3) have identified the same three risks (R1, R2, and R3) associated with integrating the first functionality (F1) provided by the third party computing system 170.

At operation 340, the computing system integration risk analysis module 300 determines a respective normalized tenant risk score for each risk identified at operation 330. As mentioned above, each of the tenant computing systems 160 may utilize different scoring values for each of the identified risks. As such, it may be difficult to generate an overall risk score for a particular functionality provided by a third party computing system 170. As such, the risk management and mitigation computing system 100 can normalize respective tenant computing system risk scores for each identified risk for the particular functionality provided by the third party computing system 170. In various aspects, the risk management and mitigation computing system 100 may normalize a risk score for the functionality provided by the third party computing system 170 (e.g., normalize the risk score across one or more determined risks for each tenant computing system of the tenant computing systems). The risk management and mitigation computing system 100 can normalize the risk score by utilizing an algorithm based on each risk score for a particular functionality provided by the third party computing system 170 and the maximum risk scores utilized by the tenant computing systems 160 that produced each risk score. Continuing the example above, the risk management and mitigation computing system 100 can determine normalized tenant risk scores for each identified risk, referring to the following notations:

| Notation | Description |
|---|---|
| F | The integrated functionality provided by the third party |
| | computing system 170 |
| Ti{i/N} | The set of tenants who have integrated the functionality F |
| Ri{i/N} | The set of risks identified for the functionality F |
| Si | The risk score of each risk Ri |
| SSi | The normalized risk score of the risk Ri |
| Smax | The maximum risk score possible, which depends on the score |
| | ranges specified for a particular tenant computing system |
| Fs | The total risk score for the functionality F |

In this example, for a given Ri for a functionality F and the maximum possible risk score, risk management and mitigation computing system 100 may normalize the risk score based on the formula SSi=Si/Smax. The risk management and mitigation computing system 100 may determine a risk score for the functionality F based on each of the risk scores determined for each of the risks in the set of risks for each tenant in the set of tenants that have integrated functionality provided by the third party computing system 170 (e.g., Fs=SS1+SS2+SS3+ . . . +SSn). In various aspects, the risk management and mitigation computing system 100 determines the Fs based on the total number of risks associated with the functionality provided by the third party computing system 170 in the context of a particular tenant (e.g., the tenant computing system 150). The risk management and mitigation computing system 100 may then determine an overall risk score for the functionality F by averaging each determined risk score across the entire set of tenants that have integrated the functionality provided by the third party computing system 170.

At operations 350, the computing system integration risk analysis module 300 determines a risk score (e.g., a normalized risk score) for each identified risk for each of the tenants (e.g., tenant computing systems 160). In operation 360, the computing system integration risk analysis module 300 determines an overall risk score for integrating the third party computing system functionality into the first party computing system 140.

TABLE 2
Exemplary Tenant Computing System Risk Data Analysis

| | | | | | | | Overall |
|---|---|---|---|---|---|---|---|
| | Risk Score | | Risk | | Standardized | Functionality Risk | Functionality Risk |
| Tenant | Ranges | Risks | Score | Level | Score | Score Per Tenant | (F1) |
| T1 | Low: 1-5 | R1 | 5 | Low | 5/15 = 0.33 | 0.33 + 0.66 + | (1.99 + 1.2 + 1.74)/ |
| | Medium: 6-10 | R2 | 10 | Medium | 10/15 = 0.66 | 1 = 1.99 | 3 = 1.64 |
| | High: 11-15 | R3 | 15 | High | 15/15 = 1 | | |
| T2 | Low: 1-2 | R1 | 1 | Low | 1/10 = 0.3 | 0.1 + 0.3 + | |
| | Medium: 3-6 | R2 | 3 | Medium | 3/10 = 0.3 | 0.8 = 1.2 | |
| | High: 7-10 | R3 | 8 | High | 8/10 = 0.8 | | |
| T3 | Low: 1-10 | R1 | 8 | Low | 8/30 = 0.27 | 0.27 + 0.57 + | |
| | Medium: 11-20 | R2 | 17 | Medium | 17/30 = 0.57 | 0.9 = 1.74 | |
| | High: 21-30 | R3 | 27 | High | 27/30 = 0.9 | | |

Additional examples of results of the risk analysis discussed above are shown in Tables 3 and 4 below with respect to different functionality (F2 and F3) provided by the third party computing system 170. As may be understood from these examples, risk scores may vary across tenants (e.g., tenant computing systems). By normalizing values across different tenant risk analyses, the risk management and mitigation computing system 100 and comparing determined risks at both the tenant level and the overall level for a particular third party computing system functionality, may provide improvements over technical defects in existing software's ability to provide accurate risk analysis related to integrating functionality provided by third party computing systems 170 (and to use that risk analysis to generate more accurate controls recommendations that provide the largest reduction in risks posed by potential data loss through the integration of such functionality). This is particularly true where data related to prior instances of integrating the functionality provided by the third party computing systems is stored in separate data repositories 168 in respective tenant computing systems 160, and may be otherwise inaccessible in configurations other than the multi-tenant system described with respect to certain aspects of the present disclosure.

TABLE 3
Exemplary Tenant Computing System Risk Data Analysis

| | | | | | | | Overall |
|---|---|---|---|---|---|---|---|
| | Risk Score | | Risk | | Standardized | Functionality Risk | Functionality Risk |
| Tenant | Ranges | Risks | Score | Level | Score | Score Per Tenant | (F2) |
| T4 | Low: 1-5 | R1 | 3 | Low | 3/15 = 0.2 | 0.2 + 0.54 + | (1.54 + 1.8 + 2.2)/ |
| | Medium: 6-10 | R2 | 8 | Medium | 8/15 = 0.54 | 0.8 = 1.54 | 3 = 1.85 |
| | High: 11-15 | R3 | 12 | High | 12/15 = 0.8 | | |
| T5 | Low: 1-2 | R1 | 2 | Low | 2/10 = 0.2 | 0.2 + 0.6 + | |
| | Medium: 3-6 | R2 | 6 | Medium | 6/10 = 0.6 | 1 = 1.8 | |
| | High: 7-10 | R3 | 10 | High | 10/10 = 1 | | |
| T6 | Low: 1-10 | R1 | 18 | Medium | 18/30 = 0.6 | 0.3 + 0.7 + | |
| | Medium: 11-20 | R2 | 21 | High | 21/30 = 0.7 | 0.9 = 1.9 | |
| | High: 21-30 | R3 | 27 | High | 27/30 = 0.9 | | |

TABLE 4
Exemplary Tenant Computing System Risk Data Analysis

| | | | | | | | Overall |
|---|---|---|---|---|---|---|---|
| | Risk Score | | Risk | | Standardized | Functionality Risk | Functionality Risk |
| Tenant | Ranges | Risks | Score | Level | Score | Score Per Tenant | (F3) |
| T7 | Low: 1-20 | R1 | 15 | Low | 15/50 = 0.3 | 0.3 + 0.7 + | (1.9 + 1.15 + 2.8)/ |
| | Medium: 21-40 | R2 | 35 | Medium | 35/50 = 0.7 | 0.9 = 1.9 | 3 = 1.95 |
| | High: 41-50 | R3 | 45 | High | 45/50 = 0.9 | | |
| T8 | Low: 1-10 | R1 | 2 | Low | 2/20 = 0.1 | 0.1 + 0.3 + | |
| | Medium: 10-15 | R2 | 3 | Low | 6/20 = 0.3 | 0.75 = 1.15 | |
| | High: 15-20 | R3 | 8 | Medium | 15/20 = 0.75 | | |
| T9 | Low: 1-2 | R1 | 4 | Medium | 4/5 = 0.8 | 0.8 + 1 + | |
| | Medium: 3-4 | R2 | 5 | High | 5/5 = 1 | 1 = 2.8 | |
| | High: 5 | R3 | 5 | High | 5/5 = 1 | | |

For illustrative purposes, the computing system integration risk analysis module 300 is described with reference to implementations described above with respect to one or more examples described herein. Other implementations, however, are possible. In some aspects, the steps in FIG. 3 may be implemented in program code that is executed by one or more computing devices such as the risk management and mitigation computing system 100, the third party computing system 140, or other system in FIG. 1. In some aspects, one or more operations shown in FIG. 3 may be omitted or performed in a different order. Similarly, additional operations not shown in FIG. 3 may be performed.

### Computing System Control Recommendation Module

FIG. 4 depicts an example of a process performed by a computing system control recommendation module 400 according to various aspects. This process includes operations that the risk management and mitigation computing system 100 may execute to generate a control recommendation to mitigate risks related to integrating the third party computing system functionality into the first party computing system 140. For instance, the flow diagram shown in FIG. 4 may correspond to operations carried out, for example, by computing hardware found in, the risk management and mitigation computing system 100 as the computing hardware executes the computing system control recommendation module 400.

At operation 410, the computing system control recommendation module 400 receives a request to mitigate risks for the third party computing system functionality integration (e.g., into a first party computing system 140). In some aspects, the computing system integration risk analysis module 300 receives the request in response to a request to integrate third party computing system functionality into the first party computing system 140 (e.g., such as discussed above with respect to operation 210 of the third party computing system integration module 200 shown in FIG. 2).

At operation 420, the computing system control recommendation module 400 accesses tenant computing system control data for risks identified for the third party computing system integration. In various aspects, the risks include risks identified as part of the computing system integration risk analysis module 300 discussed with respect to FIG. 3 (e.g., at operation 330). In some aspects, the risk management and mitigation computing system 100 accesses the tenant computing system control data from the one or more data repositories 108 on the risk management and mitigation computing system 100. In various aspects, the risk management and mitigation computing system 100 may receive and/or access the tenant computing system control data from one or more data repositories 168 in the tenant computing systems 160. In various aspects, the tenant computing system control data includes data related to one or more controls implemented by various tenant computing systems 160 when integrating the third party computing system functionality into the tenant computing systems 160 (i.e., to mitigate one or more risks identified by a respective risk analysis process performed when the tenant computing systems 160 where integrating the third party computing system functionality into the tenant computing systems 160.

In various aspects, the tenant computing system control data includes the risks identified risks by each of the tenant computing systems 160, a risk score for each of the identified risks (e.g., an absolute risk score, a normalized risk score as discussed above, etc.), a control (e.g., or controls) implemented to mitigate each risk, and a control score. The control score may, for example, indicate an extent to which the identified control reduces each identified risk (e.g., a control score of 5 may mitigate an entire risk represented by an identified risk with a risk score of 5).

At operation 430, the computing system control recommendation module 400 determines a common control set implemented for the third party computing system functionality (e.g., by each of the tenant computing systems 160). For example, the common control set may include each control that is implemented by more than one tenant computing system 160 for particular third party computing system functionality. In operation 440, the computing system control recommendation module 400 determines a mitigation weight of each control in the control set. In various aspects, the mitigation weight may indicate an extent to which each particular control (e.g., or combination of controls) mitigates a particular risk (e.g., or combination of risks) associated with integrating a particular functionality provided by a third party computing system 170.

At operation 450, the computing system control recommendation module 400 determines control adoption data for each control in the control set (e.g., by each of the tenant computing systems 160). In some aspects, the control adoption data may indicate an extent to which each particular tenant computing system 160 has implemented some kind of control to mitigate risks posed by a particular third party computing functionality. In other aspects, the control adoption data may indicate an extent to which all tenant computing systems 160 have implemented some type of control to mitigate the risks posed by a particular third party computing functionality. In still other aspects, the control adoption data may indicate an extent to which a particular control mitigates a particular risk.

In some aspects the control adoption data can include, for example, a number of tenant computing systems 160 that have implemented each particular control in the common control set, a portion (e.g., percentage) of tenant computing systems 160 that have implemented each particular control in the common control set, a number of tenant computing systems 160 that have implemented each particular control in the common control set for each particular risk in a set of risks, a portion (e.g., percentage) of tenant computing systems 160 that have implemented each particular control in the common control set for each particular risk in the set of risks, a number of tenant computing systems 160 that have implemented any type of control in the common control set, etc. In still other aspects, the control adoption data may indicate an extent to which controls have been implemented for a particular third party computing system functionality (e.g., across all tenant computing systems 160 that have integrated the functionality). In some aspects, the control adoption data may include a control mitigation score (e.g., which the computing system control recommendation module 400 may determine based on various control mitigation scores as described below).

In one example, the risk management and mitigation computing system 100 can determine the common control set, the mitigation weight, and control mitigation score of various controls, referring to the following notations:

| Notation | Description |
|---|---|
| F | The integrated functionality provided by the third party |
| | computing system 170 |
| Ti{i/N} | The set of tenants who have integrated the functionality F |
| Ri{i/N} | The set of risks identified for the functionality F |
| RRi | The residual risk rating for the risk Ri |
| Ci {i/N} | The set of controls implemented to mitigate the risks R for |
| | the functionality F |
| Ai {i/N} | The set of assessments for the functionality F |
| Si | The risk score of the risk Ri |
| SV | The sum of the risk scores of all the identified vendor |
| | risks R for the functionality F |
| CxSi | Control mitigation score, which may include an extent to |
| | which each control Cx contributes to the mitigation of the |
| | associated risk Ri. |
| CMxST | Control Mitigation score across all risks mitigated by a |
| | particular control in the context of the functionality F |
| | and the tenant |
| CMxSV | Control Mitigation Score across all risks mitigated by a |
| | particular control in the context of the functionality F |
| | and across all tenants |

In various aspects, the risk management and mitigation computing system 100 may generate one or more control recommendations to mitigate an identified risk (e.g., based on one or more determined risks and identified control implementation by the tenant computing systems 160, when integrating the third party computing system functionality). For example, given a functionality F with a total risk score S—when a control C that mitigates n risks, the extent to which the control C may affect the mitigation may be indicated by CMxST. In various aspects, the risk management and mitigation computing system 100 may determine the control mitigation score across all risks mitigated by this control C based on the individual control mitigation scores and risk scores (e.g., CMxST=(CS1+CS2= . . . +CSn)/(S1+S2+S3+ . . . . Sm)—where m is the total number of risks associated with the functionality F). When m different controls mitigate a risk Ri, the risk management and mitigation computing system 100 may uniformly distribute the control score across all the mitigating controls (e.g., CSx=Si/m).

In some aspects, the residual risk rating RRi may include a risk score that remains for a particular risk after implementation of one or more controls to mitigate the risk. In some aspects, the risk management and mitigation computing system 100 may omit the residual risk rating RRi when determining a mitigation score of a control itself. For example, in response to identifying a risk with a 10 rating, and two controls that respectively mitigate the risk by 2 and 6, the mitigation factor for these controls remains 2/10 and 6/10 respectively. A residual risk rating may, for example, automatically factor into a control mitigation score, where the risk management and mitigation computing system 100 may determine how much controls are used to mitigate risks.

In particular embodiments, the risk management and mitigation computing system 100 determines a control mitigation score for all tenants (e.g., tenant computing systems 160), in order to determine an overall mitigation score for a particular control. Various aspects, the risk management and mitigation computing system 100 performs an updated control mitigation analysis in response to a change for a particular risk score (e.g., because a control's mitigation may also change when a particular aspect of a functionality F becomes more or less risky).

In various aspects, the risk management and mitigation computing system can identify and determine, for example: (1) what control set is most widely used across a set of tenants to mitigate one or more risks associated with a particular functionality F); (2) what mitigation weight each of the controls provide to the one or more risks; (3) whether (and to what extent) any particular tenant is using controls to mitigate vendor risks; (4) etc.

Table 5 depicts an exemplary mitigation analysis for a first functionality F1:

TABLE 5
Exemplary Tenant Computing System Control Data for F1

| Tenant | Risks | Risk Score | Control | Control Score |
|---|---|---|---|---|
| T1 | R1 | 5 | C1 | 5 |
| | R2 | 10 | C2 | 10 |
| | R3 | 15 | C1 | 15 |
| | R4 | 5 | C2 | 5 |
| T2 | R5 | 1 | C1 | 1 |
| | R6 | 3 | C2 | 3 |
| T3 | R7 | 6 | C1 | 6 |
| | R8 | 8 | C2 | 8 |

In the example shown above, tenants T1, T2, and T3 (e.g., tenant computing systems T1, T2, and T3) have integrated functionality F1. The risk management and mitigation computing system 100 has identified various risks (R1, R2, R3, R4, R5, R6, R7, and R8) associated with the functionality F1 (e.g., identified from the tenant computing system control data), and the controls that have been applied to mitigate each risk are shown in Table 5 above. In the example shown in this table, each risk is mitigated by a single control (e.g., C1 or C2). As such, in this example, the control mitigation score for each of the controls is equal to the respective risk score itself.

TABLE 6
Control Mitigation Analysis for Data from Table 5

| Tenant | Control | CxS | CMxST | SV |
|---|---|---|---|---|
| T1 | C1 | 5 + 15 = 20 | 20/35 = 0.57 | 20 + 15 = 35 |
| T1 | C2 | 10 + 5 = 15 | 15/35 = 0.43 | 20 + 15 = 35 |
| T2 | C1 | 1 | 1 = /4 = 0.25 | 1 + 3 = 4 |
| T2 | C2 | 3 | 3/4 = 0.75 | 1 + 3 = 4 |
| T3 | C1 | 6 | 6/14 = 0.43 | 6 + 8 = 14 |
| T3 | C2 | 8 | 8/14 = 0.57 | 6 + 8 = 14 |

Based on the exemplary data in Table 6, the risk management and mitigation computing system 100 may determine a control mitigation score for C1 (CM1SV) of: (0.57+0.25+0.43)/3=0.42; and a control mitigation score of C2 (CM2SV) of (0.43+0.75+0.57)/3=0.58. In this example, the control set most widely used to mitigate the risks for the functionality F1 in the set of tenants (T1, T2 and T3) is C1 and C2. The mitigation weight of these two controls, in this example, are C1=0.42 and C2=0.58. In this example, the controls are being widely used to mitigate risks. For example, a control mitigation score at the tenant and functionality level includes the following:

$$T 1 : CM 1 ST 1 + C M 2 S T 1 = 0.57 + 0.43 = 1. ( 100 \% )$$

$$T 2 : CM 1 ST 2 + C M 2 S T 2 = 0.25 + 0.75 = 1. ( 100 \% )$$

$$T 3 : CM 1 ST 3 + C M 2 S T 3 = 0.43 + 0.57 = 1. ( 100 \% )$$

In this example, the risk management and mitigation computing system 100 may determine a control mitigation score at the functionality F1 level, across all identified tenants, as 100% (CMxSV=CM1SV+CM2SV=0.42+0.58=1.0 (100%)).

Table 7 depicts an exemplary mitigation analysis for a second functionality F2:

TABLE 7
Exemplary Tenant Computing System Control Data for F2

| Tenant | Risks | Risk Score | Control | Control Score |
|---|---|---|---|---|
| T1 | R1 | 5 | C1 | 2.5 |
| | R1 | 10 | C2 | 2.5 |
| | R2 | 15 | C1 | 15 |
| | R3 | 5 | C2 | 10 |
| T2 | R4 | 1 | C1 | 1 |
| | R5 | 3 | C2 | 3 |
| T3 | R7 | 6 | C1 | 6 |
| | R8 | 8 | C2 | 8 |

In the example shown above, tenants T1, T2, and T3 (e.g., tenant computing systems T1, T2, and T3) have integrated functionality F2. The risk management and mitigation computing system 100 has identified various risks (R1, R2, R3, R4, R5, R6, R7, and R8) associated with the functionality F2 (e.g., identified from the tenant computing system control data), and the controls that have been applied to mitigate each risk are shown in Table 7 above. In the example shown immediately above, there is a risk (R1) that is mitigated by more than one control (C1 and C2). In this example, the control mitigation score for each control may be distributed evenlv among the controls.

TABLE 8
Control Mitigation Analysis for Data from Table 7

| Tenant | Control | CxS | CMxST | SV |
|---|---|---|---|---|
| T1 | C1 | 2.5 + 15 = 17.5 | 17.5/30 = 0.58 | 5 + 15 + 10 = 30 |
| T1 | C2 | 2.5 + 10 = 12.5 | 12.5/35 = 0.42 | 5 + 15 + 10 = 30 |
| T2 | C1 | 1 | 1/4 = 0.25 | 4 |
| T2 | C2 | 3 | 3/4 = 0.75 | 4 |
| T3 | C1 | 6 | 6/14 = 0.43 | 14 |
| T3 | C2 | 8 | 8/14 = 0.57 | 14 |

Based on the exemplary data in Table 8, the risk management and mitigation computing system 100 may determine a control mitigation score for C1 (CM1SV) of: (0.58+0.25+0.43)/3=0.42; and a control mitigation score of C2 (CM2SV) of (0.42+0.75+0.57)/3=0.58. In this example, the control set most widely used to mitigate the risks for the functionality F2 in the set of tenants (T1, T2 and T3) is C1 and C2. The mitigation weight of these two controls, in this example, are C1=0.58 and C2-0.42. In this example, the controls are being widely used to mitigate risks. For example, a control mitigation score at the tenant and functionality level includes the following:

$$T 1 : CM 1 ST 1 + C M 2 S T 1 = 0.58 + 0 \; 42 = 1. ( 100 \% )$$

$$T 2 : CM 1 ST 2 + C M 2 S T 2 = 0.25 + 0.75 = 1. ( 100 \% )$$

$$T 3 : CM 1 ST 3 + C M 2 S T 3 = 0.43 + 0.57 = 1. ( 100 \% )$$

In this example, the risk management and mitigation computing system 100 may determine a control mitigation score at the functionality F2 level, across all identified tenants, as 100% (CMxSV=CM1SV+CM2SV=0.42+0.58=1.0 (100%)).

Table 9 depicts an exemplary mitigation analysis for a third functionality F3:

TABLE 9
Exemplary Tenant Computing System Control Data for F3

| Tenant | Risks | Risk Score | Control | Control Score |
|---|---|---|---|---|
| T1 | R1 | 5 | C1 | 5 |
| | R2 | 5 | C2 | 5 |
| | R3 | 15 | C1 | 15 |
| | R4 | 10 | C2 | 10 |
| T2 | R5 | 1 | C3 | 1 |
| | R6 | 3 | C4 | 3 |
| T3 | R7 | 6 | C1 | 6 |
| | R8 | 8 | C2 | 8 |
| T4 | R9 | 10 | C3 | 10 |
| | R10 | 15 | C4 | 15 |

In the example shown above, tenants T1, T2, T3, and T4 have integrated functionality F3. The risk management and mitigation computing system 100 has identified various risks (R1, R2, R3, R4, R5, R6, R7, R8, R9, and R10) associated with the functionality F3 (e.g., identified from the tenant computing system control data), and the controls that have been applied to mitigate each risk are shown in Table 9 above. In the example shown in this table, Tenants T1 and T3 use a set of controls (C1, C2) to mitigate various risks, while T2 and T4 use a different set of controls (C3, C4) to mitigate risks identified for functionality F3.

TABLE 10
Control Mitigation Analysis for Data from Table 9

| Tenant | Control | CxS | CMxST | SV |
|---|---|---|---|---|
| T1 | C1 | 5 + 15 = 20 | 20/35 = 0.57 | 20 + 15 = 35 |
| T1 | C2 | 10 + 5 = 15 | 15/35 = 0.43 | 20 = 15 = 35 |
| T2 | C3 | 1 | 1/4 = 0.25 | 1 + 3 = 4 |
| T2 | C4 | 3 | 3/4 = 0.75 | 1 + 3 = 4 |
| T3 | C1 | 6 | 6/14 = 0.43 | 6 + 8 = 14 |
| T3 | C2 | 8 | 8/14 = 0.57 | 6 + 8 = 14 |
| T4 | C3 | 10 | 10/25 = 0.4 | 10 + 15 = 25 |
| T4 | C4 | 15 | 15/25 = 0.6 | 10 + 15 = 25 |

Based on the exemplary data in Table 10, the risk management and mitigation computing system 100 may determine a control mitigation score for C1 (CM1SV) of: (0.57+0.43)/4=0.25; a control mitigation score of C2 (CM2SV) of (0.43+0.57)/4=0.25; a control mitigation score of C3 (CM3SV) of (0.25+0.4)/4=0.16; and a control mitigation score of C4 (CM4SV) of (0.75+0.6)/4=0.34. In this example, the control set most widely used to mitigate the risks for the functionality F3 in the set of tenants (T1, T2, T3 and T4) are C1, C2, C3, and C4. The mitigation weight of these four controls, in this example, are C1=0.25; C2=0.25; C3=0.16; and C4=0.34. In this example, the controls are being widely used to mitigate risks. For example, a control mitigation score at the tenant and functionality level includes the following:

$$T 1 : CM 1 ST 1 + C M 2 S T 1 = 0.58 + 0.42 = 1. ( 100 \% )$$

$$T 2 : CM 3 ST 2 + C M 4 S T 2 = 0.25 + 0.75 = 1. ( 100 \% )$$

$$T 3 : CM 1 ST 3 + C M 2 S T 3 = 0.43 + 0.57 = 1. ( 100 \% )$$

$$T 4 : CM 3 ST 3 + C M 4 S T 3 = 0.40 + 0.60 = 1. ( 100 \% )$$

In this example, the risk management and mitigation computing system 100 may determine a control mitigation score at the vendor level, across all identified tenants, as 100% (CMxSV=CM1SV+CM2SV+CM3SV=CM4SV=0.25+0.25+0.16+0.34=1.0 (100%)).

Table 11 depicts an exemplary mitigation analysis for a fourth functionality F4:

TABLE 11
Exemplary Tenant Computing System Control Data for F4

| Tenant | Risks | Risk Score | Control | Control Score |
|---|---|---|---|---|
| T1 | R1 | 5 | C1 | 5 |
| | R2 | 5 | C2 | 5 |
| | R3 | 15 | C1 | 15 |
| | R4 | 10 | C2 | 10 |
| T2 | R5 | 1 | C3 | 1 |
| | R6 | 3 | C4 | 3 |
| T3 | R7 | 6 | C1 | 6 |
| | R8 | 8 | Nil | 0 |
| T4 | R9 | 10 | C3 | 10 |
| | R10 | 15 | Nil | 0 |

In the example shown above, tenants T1, T2, T3, and T4 (e.g., tenant computing systems T1, T2, T3, and T4) have integrated functionality F1. The risk management and mitigation computing system 100 has identified various risks (R1, R2, R3, R4, R5, R6, R7, R8, R9, and R10) associated with the functionality F4 (e.g., identified from the tenant computing system control data), and the controls that have been applied to mitigate each risk are shown in Table 11 above. In the example shown immediately above, not all tenants use controls to mitigate every risk (e.g., tenants T3 and T4 do not have controls implemented for risks R8 and R10 respectively).

TABLE 12
Control Mitigation Analysis for Data from Table 11

| Tenant | Control | CxS | CMxST | SV |
|---|---|---|---|---|
| T1 | C1 | 5 + 15 = 20 | 20/35 = 0.57 | 20 + 15 = 35 |
| T1 | C2 | 10 + 5 = 15 | 15/35 = 0.43 | 20 = 15 = 35 |
| T2 | C3 | 1 | 1/4 = 0.25 | 1 + 3 = 4 |
| T2 | C4 | 3 | 3/4 = 0.75 | 1 + 3 = 4 |
| T3 | C1 | 6 | 6/14 = 0.43 | 6 + 8 = 14 |
| T3 | Nil | 0 | 0 | 0 |
| T4 | C3 | 10 | 10/25 = 0.4 | 10 + 15 = 25 |
| T4 | Nil | 0 | 0 | 0 |

Based on the exemplary data in Table 12, the risk management and mitigation computing system 100 may determine a control mitigation score for C1 (CM1SV) of: (0.57+0.43)/4=0.25; a control mitigation score of C2 (CM2SV) of (0.43)/4=0.11; a control mitigation score of C3 (CM3SV) of (0.25+0.4)/4=0.16; and a control mitigation score of C4 (CM4SV) of (0.75)/4=0.19. In this example, the control set most widely used to mitigate the risks for the functionality F4 in the set of tenants (T1, T2, T3 and T4) includes C1, C2, C3, and C4. The mitigation weight of these four controls, in this example, are C1=0.25; C2=0.11; C3=0.16; and C4=0.19. In this example, the controls are being widely used to mitigate risks. For example, a control mitigation score at the tenant and vendor level includes the following:

$$T 1 : CM 1 ST 1 + C M 2 S T 1 = 0.57 + 0.43 = 1. ( 100 \% )$$

$$T 2 : CM 3 ST 2 + C M 4 S T 2 = 0.25 + 0.75 = 1. ( 100 \% )$$

$$T 3 : CM 1 ST 3 = 0.43 ( 43 \% )$$

$$T 4 : CM 3 ST 3 = 0.4 ( 40 \% )$$

In this example, the risk management and mitigation computing system 100 may determine a control mitigation score at the functionality F4 level, across all identified tenants, as 71% (CMxSV=CM1SV+CM2SV+CM3SV=CM4SV=0.25+0.11+0.16+0.19=0.71 (71%)).

Returning to operation 460, the computing system control recommendation module 400 generates a control recommendation based on the common control set, the mitigation weight of each control in the control set, and the control adoption data (e.g., the control mitigation score).

In various aspects, the computing system control recommendation module 400 may process the common control set, the mitigation weight of each control in the control set, and the control adoption data using a rules-based model, a machine-learning model, or both to generate the control recommendation. For example, the rules-based model, machine learning model, or combination of both may be configured to process the common control set, the mitigation weight of each control in the control set, and the control adoption data, and/or the like in determining a control recommendation(s). In other aspects, the rules-based model, machine learning model, or combination of both may be configured to process the residual risk rating to generate the control recommendation. For example, the rules-based model, machine learning model, or combination of both may be configured to generate a control recommendation by identifying which of a plurality of controls in the common control set result in the lowest residual risk rating for a particular set of risks.

For example, according to particular aspects, the computing system control recommendation module 400 may involve using a rules-based model in generating the control recommendation. The rules-based model may comprise a set of rules that selects at least one control from the common control set based on the mitigation weight of each control and the control adoption data. For example, the set of rules may define one or more rules for selecting the most mitigating control(s) according to mitigation weight, the most commonly adopted control for the particular functionality at issue, etc. In other aspects, the set of rules may define one or more rules for ordering each of the controls in common control set in terms of priority (e.g., most mitigating control to least mitigating control). Accordingly, an entity (e.g., on the first party computing system 140, the risk management and mitigation computing system 100) may maintain the set of rules in some type of data storage, such as a database (e.g., the one or more data repositories 108), from which the risk management and mitigation computing system 100 can access the set of rules for generating the control recommendation.

In some aspects, the rules-based model comprises a set of rules that selects the control recommendation from the common control set based on a relative mitigation weight of each control in the common control set or a relative adoption rate of each control in the common control set. For example, the computing system control recommendation module 400 may use the rules-based model to determine which control in the common control set provides the largest mitigation weight (e.g., which control provides the most mitigation for a particular identified risk), and select the control as the control recommendation. In other aspects, the computing system control recommendation module 400 may use the rules-based model to determine an adoption rate of each control in the common control set (e.g., a rate at which the tenant computing systems 160 have adopted each particular control for an identified risk). The computing system control recommendation module 400 may the use the rules-based model to select the control with the highest adoption rate as the control recommendation.

According to other aspects, the computing system control recommendation module 400 may utilize a machine learning model in generating a control recommendation related to integrating the functionality provided by the third party computing system. Here, the machine learning model may be trained using historical data on determined risks, risk scoring, mitigating control use, etc. by other tenants (e.g., tenant computing systems 160) that have integrated the functionality provided by the third party computing system 170. For instance, according to some aspects, the machine learning model may generate a control recommendation based on a prediction as to a reduction in likelihood of the first party computing system 140 experiencing a data privacy incident through integration of the functionality provided by the third party computing system 170 with the recommended control in place. Accordingly, the machine learning model may be configured using a variety of different types of supervised or unsupervised trained models such as, for example, support vector machine, naive Bayes, decision tree, neural network, and/or the like.

According to still other aspects, the computing system control recommendation module 400 may involve using a combination of the rules-based model and the machine learning model in generating a recommended control (e.g., a recommended control action). In various aspects, the risk management and mitigation computing system 100 may modify the tenant computing system control data to include the generated recommendation in association with the first party computing system and at least one of the identified risks. For example, the risk management and mitigation computing system 100 may modify the tenant computing system control data to include new control data for the first party computing system 140, the new control data indicating the control recommendation as a control implemented by the first party computing system 140 for at least one of the particular risks. In such aspects, the risk management and mitigation computing system 100 may provide the updated tenant computing system control data to a subsequent first party computing system that is integrating (e.g., or requesting to integrate) the third party computing system functionality (e.g., for use in risk analysis or control recommendation for the subsequent integration). In other aspects, the new control data may be fed to the machine learning model as training data. For illustrative purposes, the computing system control recommendation module 400 is described with reference to implementations described above with respect to one or more examples described herein. Other implementations, however, are possible. In some aspects, the steps in FIG. 4 may be implemented in program code that is executed by one or more computing devices such as the risk management and mitigation computing system 100, the first party computing system 140, or other system in FIG. 1. In some aspects, one or more operations shown in FIG. 4 may be omitted or performed in a different order. Similarly, additional operations not shown in FIG. 4 may be performed.

### Third Party Computing System Control Implementation Module

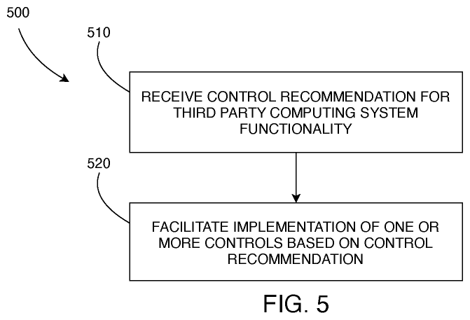

FIG. 5 depicts an example of a process, performed by a third party computing system control implementation module 500, according to various aspects. This process include operations that the first party computing system 140 may execute to facilitate implementation of one or more controls based on a control recommendation for integrating the third party computing system functionality into the first party computing system 140. For instance, the flow diagram shown in FIG. 5 may correspond to operations carried out, for example, by computing hardware found in, the first party computing system 140 as the computing hardware executes the third party computing system control implementation module 500.

At operation 510, the third party computing system control implementation module 500, receives the control recommendation for the third party computing system functionality. In various aspects, the first party computing system 140 receives the control recommendation (e.g., including one or more controls designed to mitigate at least one risk related to the integration of the third party computing system functionality) from the risk management and mitigation computing system 100 (e.g., following the generation of the control recommendation during execution of the computing system control recommendation module 400 described with respect to FIG. 4).

At operation 520, the third party computing system control implementation module 500, facilitates implementation of one or more controls based on the control recommendation. For example, the first party computing system may modify the functionality provided by the third party computing system (e.g. or cause the third party computing system 170 to modify the functionality). In various aspects the first party computing system 140 may modify the functionality according to the one or more controls. In some aspects, the first party computing system may disable the functionality provided by the third party computing system. In other aspects, the first party computing system may modify network communications between the first party computing system and third party computing system. In other aspects, the first party computing system may modify one or more attributes of the first party computing system and/or the third party computing system (e.g., or facilitate their modification) in order to implement the recommended control.

In other aspects, the first party computing system 140 may generate a graphical user interface by configuring one or more display elements for displaying the recommended control, the set of risks, or any other data described herein. In such aspects the third party computing system control implementation module 500 may facilitate implementation of the one or more controls by providing the graphical user interface for display on a user device.

For illustrative purposes, the third party computing system control implementation module 500 is described with reference to implementations described above with respect to one or more examples described herein. Other implementations, however, are possible. In some aspects, the steps in FIG. 5 may be implemented in program code that is executed by one or more computing devices such as the risk management and mitigation computing system 100, the first party computing system 140, or other system in FIG. 1. In some aspects, one or more operations shown in FIG. 5 may be omitted or performed in a different order. Similarly, additional operations not shown in FIG. 5 may be performed.

### Example Technical Platforms

Aspects of the present disclosure may be implemented in various ways, including as computer program products that include articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example aspects, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

According to various aspects, a non-volatile computer-readable storage medium may include a floppy disk, flexible disk, hard disk, solid-state storage (SSS) (e.g., a solid-state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

According to various aspects, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where various aspects are described to use a computer-readable storage medium, other types of computer-readable storage media may be substituted for or used in addition to the computer-readable storage media described above.

Various aspects of the present disclosure may also be implemented as methods, apparatuses, systems, computing devices, computing entities, and/or the like. As such, various aspects of the present disclosure may take the form of a data structure, apparatus, system, computing device, computing entity, and/or the like executing instructions stored on a computer-readable storage medium to perform certain steps or operations. Thus, various aspects of the present disclosure also may take the form of entirely hardware, entirely computer program product, and/or a combination of computer program product and hardware performing certain steps or operations.

Various aspects of the present disclosure are described below with reference to block diagrams and flowchart illustrations. Thus, each block of the block diagrams and flowchart illustrations may be implemented in the form of a computer program product, an entirely hardware aspect, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some examples of aspects, retrieval, loading, and/or execution may be performed in parallel such that multiple instructions are retrieved, loaded, and/or executed together. Thus, such aspects can produce specially configured machines performing the steps or operations specified in the block diagrams and flowchart illustrations. Accordingly, the block diagrams and flowchart illustrations support various combinations of aspects for performing the specified instructions, operations, or steps.

### Example System Architecture

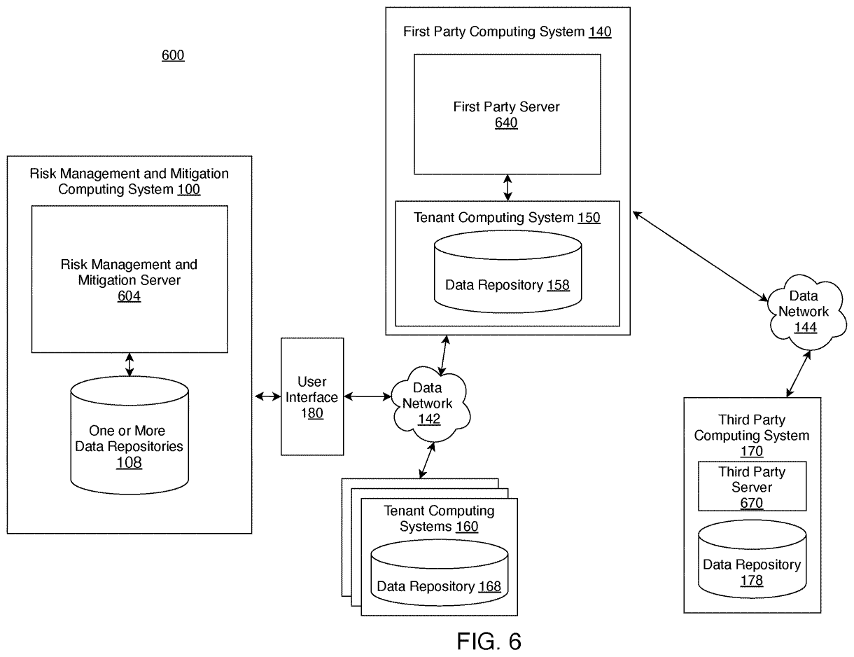

FIG. 6 depicts an example of a computing environment that can be used for for analyzing data-related risks associated with integrating functionality provided by a third party computing system into a tenant computing system and facilitating implementation of controls to mitigate the identified risks accordance with various aspects of the present disclosure. Components of the system architecture 600 are configured according to various aspects to analyze risk associated with integrating third party computing system functionality into a first party computing system 140 and generate recommendations for mitigating those risks on a risk management and mitigation computing system 100

The system architecture 600 according to various aspects may include a risk management and mitigation computing system 100 and one or more data repositories 108. The risk management and mitigation computing system 100 further includes risk management and mitigation server 604. Although the risk management and mitigation computing system 100 and one or more data repositories 108 are shown as separate components, according to other aspects, these components may include a single server and/or repository, servers and/or repositories, one or more cloud-based servers and/or repositories, or any other suitable configuration.

In addition, the system architecture 600 according to various aspects may include a first-party computing system 140 that includes one or more first party servers 640 and a tenant computing system 150 comprising one or more data repositories 158. Although the first party server 640, first party computing system 140, tenant computing system 150, and one or more data repositories 158 are shown as separate components, according to other aspects, these components 170, 670, 150, 158 may include a single server and/or repository, servers and/or repositories, one or more cloud-based servers and/or repositories, or any other suitable configuration.

In addition, the system architecture 600 according to various aspects may include a third-party computing system 170 that includes one or more third party servers 670. Although the third party server 670 and third-party computing system 170 are shown as separate components, according to other aspects, these components 170, 670 may include a single server and/or repository, servers and/or repositories, one or more cloud-based servers and/or repositories, or any other suitable configuration.

In other aspects, the system architecture 600 may include a tenant computing system 160 comprising a data repository 168. Although the tenant computing system 160 and the data repository 168 are shown as separate components, according to other aspects, these components 160, 168 may include a single server and/or repository, servers and/or repositories, one or more cloud-based servers and/or repositories, or any other suitable configuration.

The risk management and mitigation server 604, first party server 640, and/or other components may communicate with, access, and/or the like with each other over one or more networks, such as via a data network 142 (e.g., a public data network, a private data network, etc.) and/or a data network 144 (e.g., a public data network, a private data network, etc.). In some aspects, the first party server 640, the risk management and mitigation server 604, and/or the third party server 670 may provide one or more interfaces that allow the first party computing system 140, the third party computing system 170, and/or the risk management and mitigation computing system 100 to communicate with each other such as one or more suitable application programming interfaces (APIs), direct connections, and/or the like.

### Example Computing Hardware

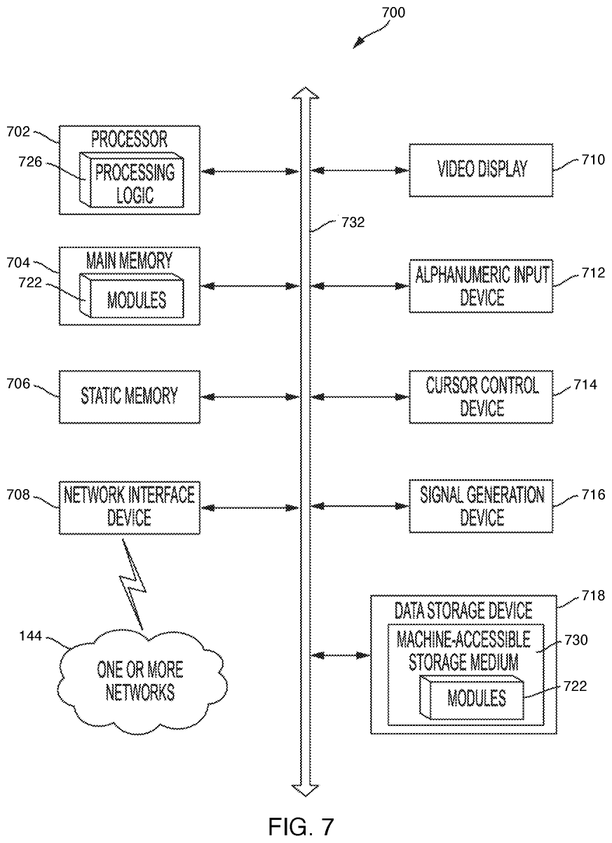

FIG. 7 illustrates a diagrammatic representation of a computing hardware device 700 that may be used in accordance with various aspects of the disclosure. For example, the hardware device 700 may be computing hardware such as a risk management and mitigation server 604 and/or a first party server 640 as described in FIG. 6. According to particular aspects, the hardware device 700 may be connected (e.g., networked) to one or more other computing entities, storage devices, and/or the like via one or more networks such as, for example, a LAN, an intranet, an extranet, and/or the Internet. As noted above, the hardware device 700 may operate in the capacity of a server and/or a client device in a client-server network environment, or as a peer computing device in a peer-to-peer (or distributed) network environment. According to various aspects, the hardware device 700 may be a personal computer (PC), a tablet PC, a set-top box (STB), a Personal Digital Assistant (PDA), a mobile device (smartphone), a web appliance, a server, a network router, a switch or bridge, or any other device capable of executing a set of instructions (sequential or otherwise) that specify actions to be taken by that device. Further, while only a single hardware device 700 is illustrated, the term “hardware device,” “computing hardware,” and/or the like shall also be taken to include any collection of computing entities that individually or jointly execute a set (or multiple sets) of instructions to perform any one or more of the methodologies discussed herein.

A hardware device 700 includes a processor 702, a main memory 704 (e.g., read-only memory (ROM), flash memory, dynamic random-access memory (DRAM) such as synchronous DRAM (SDRAM), Rambus DRAM (RDRAM), and/or the like), a static memory 706 (e.g., flash memory, static random-access memory (SRAM), and/or the like), and a data storage device 718, that communicate with each other via a bus 732.

The processor 702 may represent one or more general-purpose processing devices such as a microprocessor, a central processing unit, and/or the like. According to some aspects, the processor 702 may be a complex instruction set computing (CISC) microprocessor, reduced instruction set computing (RISC) microprocessor, very long instruction word (VLIW) microprocessor, a processor implementing other instruction sets, processors implementing a combination of instruction sets, and/or the like. According to some aspects, the processor 702 may be one or more special-purpose processing devices such as an application specific integrated circuit (ASIC), a field programmable gate array (FPGA), a digital signal processor (DSP), network processor, and/or the like. The processor 702 can execute processing logic 726 for performing various operations and/or steps described herein.

The hardware device 700 may further include a network interface device 808, as well as a video display unit 710 (e.g., a liquid crystal display (LCD), a cathode ray tube (CRT), and/or the like), an alphanumeric input device 712 (e.g., a keyboard), a cursor control device 714 (e.g., a mouse, a trackpad), and/or a signal generation device 816 (e.g., a speaker). The hardware device 800 may further include a data storage device 718. The data storage device 718 may include a non-transitory computer-readable storage medium 730 (also known as a non-transitory computer-readable storage medium or a non-transitory computer-readable medium) on which is stored one or more modules 722 (e.g., sets of software instructions) embodying any one or more of the methodologies or functions described herein. For instance, according to particular aspects, the modules 722 include the third party computing system integration module 200, the computing system integration risk analysis module 300, the computing system control recommendation module 400, and the third party computing system control implementation module 500 as described herein. The one or more modules 722 may also reside, completely or at least partially, within main memory 704 and/or within the processor 702 during execution thereof by the hardware device 700—main memory 8704 and processor 702 also constituting computer-accessible storage media. The one or more modules 22 may further be transmitted or received over a network 142 via the network interface device 708.

While the computer-readable storage medium 730 is shown to be a single medium, the terms “computer-readable storage medium” and “machine-accessible storage medium” should be understood to include a single medium or multiple media (e.g., a centralized or distributed database, and/or associated caches and servers) that store the one or more sets of instructions. The term “computer-readable storage medium” should also be understood to include any medium that is capable of storing, encoding, and/or carrying a set of instructions for execution by the hardware device 700 and that causes the hardware device 700 to perform any one or more of the methodologies of the present disclosure. The term “computer-readable storage medium” should accordingly be understood to include, but not be limited to, solid-state memories, optical and magnetic media, and/or the like.

### System Operation

The logical operations described herein may be implemented (1) as a sequence of computer implemented acts or one or more program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, steps, structural devices, acts, or modules. These states, operations, steps, structural devices, acts, and modules may be implemented in software, in firmware, in special purpose digital logic, and any combination thereof. Greater or fewer operations may be performed than shown in the figures and described herein. These operations also may be performed in a different order than those described herein.

### CONCLUSION

While this specification contains many specific aspect details, these should not be construed as limitations on the scope of any invention or of what may be claimed, but rather as descriptions of features that may be specific to particular aspects of particular inventions. Certain features that are described in this specification in the context of separate aspects also may be implemented in combination in a single aspect. Conversely, various features that are described in the context of a single aspect also may be implemented in multiple aspects separately or in any suitable sub-combination. Moreover, although features may be described above as acting in certain combinations and even initially claimed as such, one or more features from a claimed combination may in some cases be excised from the combination, and the claimed combination may be a sub-combination or variation of a sub-combination.

Similarly, while operations are described in a particular order, this should not be understood as requiring that such operations be performed in the particular order described or in sequential order, or that all described operations be performed, to achieve desirable results. In certain circumstances, multitasking and parallel processing may be advantageous. Moreover, the separation of various components in the various aspects described above should not be understood as requiring such separation in all aspects, and the described program components (e.g., modules) and systems may be integrated together in a single software product or packaged into multiple software products.

Many modifications and other aspects of the disclosure will come to mind to one skilled in the art to which this disclosure pertains having the benefit of the teachings presented in the foregoing descriptions and the associated drawings. Therefore, it is to be understood that the disclosure is not to be limited to the specific aspects disclosed and that modifications and other aspects are intended to be included within the scope of the appended claims. Although specific terms are employed herein, they are used in a generic and descriptive sense only and not for the purposes of limitation.

What is claimed is:

1. A computer-implemented method comprising:
accessing, by computing hardware, tenant computing system control data for a plurality of tenant computing systems that have previously integrated functionality provided by a third party computing system, the tenant computing system control data indicating controls implemented by the plurality of tenant computing systems to mitigate risks associated with integrating the functionality provided by the third party computing system;
causing, by the computing hardware, a machine-learning model to process the tenant computing system control data to generate a control recommendation for integrating the functionality provided by the third party computing system into a first party computing system, the machine-learning model having been trained using historical tenant computing system control data;
modifying, by the computing hardware, the tenant computing system control data to include new control data for the first party computing system, the new control data indicating the control recommendation as a control implemented by the first party computing system; and
providing, by the computing hardware, the modified tenant computing system control data as training data for the machine-learning model.

2. The method of claim 1, further comprising accessing, by the computing hardware, tenant computing system risk data for the plurality of tenant computing systems, the tenant computing system risk data comprising risk data for each of the plurality of tenant computing systems that have previously integrated the functionality provided by the third party computing system, and determining, by the computing hardware, a respective normalized risk score for each of a plurality of particular risks identified based on the tenant computing system risk data for each tenant computing system of the plurality of tenant computing systems.

3. The method of claim 2, further comprising determining, by the computing hardware based on the tenant computing system control data, a common control set implemented by the plurality of tenant computing systems to mitigate the plurality of particular risks for integrating the functionality provided by the third party computing system, and determining a mitigation weight of each control in the common control set based on the respective normalized risk score for each of the plurality of particular risks and the tenant computing system control data, wherein the machine-learning model processes the common control set and the mitigation weight to generate the control recommendation.

4. The method of claim 1, wherein causing the machine-learning model to process the tenant computing system control data to generate the control recommendation further comprises processing, by the computing hardware, the tenant computing system control data using a combination of the machine-learning model and a rules-based model, the rules-based model comprising a set of rules that selects the control recommendation based on at least one of a relative mitigation weight of each control or a relative adoption rate of each control.

5. The method of claim 1, further comprising determining, by the computing hardware, a residual risk rating for each of a plurality of particular risks based on a respective normalized risk score for each of the plurality of particular risks and a mitigation weight of each control in a common control set, wherein the machine-learning model generates the control recommendation further based on the residual risk rating.

6. The method of claim 1, further comprising facilitating, by the computing hardware, implementation of the control recommendation at the first party computing system, wherein facilitating implementation of the control recommendation comprises at least one of facilitating modification of the functionality provided by the third party computing system, facilitating disabling of the functionality provided by the third party computing system, or generating a user interface that includes the control recommendation and providing the user interface for display on a user device.

7. The method of claim 1, wherein the machine-learning model comprises at least one of a support vector machine, a naive Bayes classifier, a decision tree, or a neural network, and wherein the machine-learning model generates the control recommendation based on a prediction of a reduction in likelihood of the first party computing system experiencing a data privacy incident through integration of the functionality provided by the third party computing system.

8. A method comprising:
accessing, by computing hardware, tenant computing system risk data and tenant computing system control data from a plurality of data repositories associated with a plurality of tenant computing systems in a multi-tenant environment, the tenant computing system risk data comprising risk data determined during prior integrations of functionality provided by a third party computing system by the plurality of tenant computing systems;
anonymizing, by the computing hardware, the tenant computing system risk data and the tenant computing system control data such that the tenant computing system risk data and the tenant computing system control data are available for risk analysis and control recommendation processes without identifying which of the plurality of tenant computing systems assigned a particular risk level or implemented a particular control;
determining, by the computing hardware and based on the anonymized tenant computing system risk data, one or more risks associated with integrating the functionality provided by the third party computing system into a first party computing system; and
generating, by the computing hardware, a control recommendation for mitigating the one or more risks based on the anonymized tenant computing system control data.

9. The method of claim 8, further comprising determining, by the computing hardware and based on the anonymized tenant computing system risk data, a respective normalized risk score for each of the one or more risks for each tenant computing system of the plurality of tenant computing systems by normalizing risk scores across different scoring scales used by respective tenant computing systems.

10. The method of claim 8, further comprising determining, by the computing hardware and based on the anonymized tenant computing system control data, a common control set implemented by the plurality of tenant computing systems to mitigate the one or more risks associated with integrating the functionality provided by the third party computing system.

11. The method of claim 10, further comprising determining, by the computing hardware, a mitigation weight of each control in the common control set based on a respective normalized risk score for each of the one or more risks and the anonymized tenant computing system control data, and determining control adoption data indicating an extent to which each control in the common control set has been implemented by the plurality of tenant computing systems.

12. The method of claim 8, wherein generating the control recommendation comprises causing at least one of a rules-based model or a machine-learning model to process the anonymized tenant computing system control data to generate the control recommendation, the control recommendation comprising at least one control from a common control set implemented by the plurality of tenant computing systems.

13. The method of claim 8, further comprising generating, by the computing hardware, a graphical user interface by configuring one or more display elements for displaying the control recommendation and at least one of the one or more risks, and providing the graphical user interface for display on a user device.

14. The method of claim 8, further comprising modifying, by the computing hardware, the anonymized tenant computing system control data to include new control data for the first party computing system, the new control data indicating the control recommendation as a control implemented by the first party computing system for at least one of the one or more risks, and providing the modified anonymized tenant computing system control data for use in a subsequent risk analysis for a subsequent integration of the functionality provided by the third party computing system.

15. An apparatus comprising:
one or more processors; and
memory storing process-executable instructions that, when executed by the one or more processors, cause the apparatus to:
access tenant computing system control data for a plurality of tenant computing systems that have previously integrated functionality provided by a third party computing system, the tenant computing system control data indicating controls implemented by the plurality of tenant computing systems to mitigate risks associated with integrating the functionality provided by the third party computing system;
cause a machine-learning model to process the tenant computing system control data to generate a control recommendation for integrating the functionality provided by the third party computing system into a first party computing system, the machine-learning model having been trained using historical tenant computing system control data;
modify the tenant computing system control data to include new control data for the first party computing system, the new control data indicating the control recommendation as a control implemented by the first party computing system; and
provide the modified tenant computing system control data as training data for the machine-learning model.

16. The apparatus of claim 15, wherein the process-executable instructions further cause the apparatus to access tenant computing system risk data for the plurality of tenant computing systems, the tenant computing system risk data comprising risk data for each of the plurality of tenant computing systems that have previously integrated the functionality provided by the third party computing system, and determine a respective normalized risk score for each of a plurality of particular risks identified based on the tenant computing system risk data.

17. The apparatus of claim 15, wherein the process-executable instructions further cause the apparatus to determine, based on the tenant computing system control data, a common control set implemented by the plurality of tenant computing systems to mitigate risks for integrating the functionality provided by the third party computing system, and determine a mitigation weight of each control in the common control set based on a respective normalized risk score for each of a plurality of particular risks and the tenant computing system control data.

18. The apparatus of claim 15, wherein the process-executable instructions further cause the apparatus to process the tenant computing system control data using a combination of the machine-learning model and a rules-based model, the rules-based model comprising a set of rules that selects the control recommendation based on at least one of a relative mitigation weight of each control or a relative adoption rate of each control.

19. The apparatus of claim 15, wherein the process-executable instructions further cause the apparatus to determine a residual risk rating for each of a plurality of particular risks based on a respective normalized risk score for each of the plurality of particular risks and a mitigation weight of each control in a common control set, and wherein the machine-learning model generates the control recommendation further based on the residual risk rating.

20. The apparatus of claim 15, wherein the process-executable instructions further cause the apparatus to facilitate implementation of the control recommendation at the first party computing system by at least one of facilitating modification of the functionality provided by the third party computing system, facilitating disabling of the functionality provided by the third party computing system, or generating a user interface that includes the control recommendation and providing the user interface for display on a user device.
